(19) United States
(12) Patent Application Publication
(10) Pub. No.: US 2010/0217412 A1
(43) Pub. Date: Aug. 26, 2010

(54) WIRELESS COMMUNICATION DEVICE AND SYSTEM

(75) Inventor: Robert Abraham, Surrey (GB)

Correspondence Address: MCKEE, VOORHEES & SEASE, P.L.C., 801 GRAND AVENUE, SUITE 3200, DES MOINES, IA, 50309-2721, US

(73) Assignee: ARMOUR HOME ELECTRONICS LTD, WOKING, SURREY (GB)

(21) Appl. No.: 12/672,941

(22) PCT Filed: Sep. 18, 2008
(86) PCT No.: PCT/GB2008/003157

§ 371 Date: Feb. 25, 2010

(30) Foreign Application Priority Data
Sep. 20, 2007 (GB) 0718362.7

(51) Int. Cl. G06F 17/00; H04B 5/00

(52) U.S. Cl. 700/94; 381/79

(57) ABSTRACT

The invention relates to a system and method which allows audio and/or video signals transmitted from a source device, such as an MP3/MP4 player to be transmitted to a host device such as speakers and/or a display screen via a wireless communication device. The system allows command signals generated from the source device and/or the wireless communication device to also be transmitted to the host device, and may receive data in return from the host device, said data typically indicative of at least one operating feature or parameter of the host device.

The invention to which this application relates is a device for transmitting and/or receiving data and audio & video signals from a source device to an output means with a receiver, wirelessly. The invention also relates to a method of wireless control of a host device such as a speaker system.

There are a number of systems on the market designed to act as source devices to facilitate the wired connection of data & audio & A/V sources, such as music-playing mobile phones or MP3/MP4 players, to playback devices such as amplified speaker systems, televisions, audio/video systems, and the like. A user can select a particular soundtrack on the source device, and audio and /or video is relayed therefrom to the speaker system via the wired connection.

However, all of the known systems require the source device to be docked in a suitable docking station to facilitate the wired connection or be connected via a plug in cable. This is not ideal, because, from a distance, the display on the source device is difficult to read and the source device is located in a fixed position which may not always be easily accessible. Wireless devices are known but do not permit any control over the host device, which means that the user is still required to hold and use the host device remote control which is inconvenient. Furthermore an additional remote control is required to control settings such as track selection and volume on the source device, which means that the user must inconveniently learn a second way to navigate the product, and of course adds to the number of remote controls a user may already have.

In more recent times, wireless systems such as Bluetooth have been used specifically with music-playing mobile phones to wirelessly transmit audio to a receiving amplified speaker system. However, whilst the mobile phone may remain in the palm of the user's hand for convenient navigation through musical tracks, no control is possible of the speaker system. This means that functions of the speaker system such as on/off and volume have to be controlled manually or via a separate device.

An aim of the present invention is to provide apparatus which allows the wireless connection of a source device which may typically be portable and is desired to be hand held in use, with one or more host devices or output means such as playback speakers or earphones to allow audio or a/v signals which may be provided in an analogue or digital form, from the source device to be used to create sound through the speakers. A further aim of the invention is to allow remote control of the host device via the apparatus to overcome the above problems.

In one aspect of the invention, there is provided a system for audio and/or video reproduction said system including a wireless communication device for association with a source device, said wireless communication device including transmitting means for transmitting data and/or audio and/or a/v signals from the source device to a host device, characterised in that the data and/or signals which are transmitted are generated from the source device and/or wireless communication device, and are used to control at least one feature of operation of the host device and/or allow the generation of audio and/or video therefrom.

In one embodiment the data which is transmitted selectively includes control commands for the host device.

In one embodiment the host device is one or more speakers. In on embodiment the host device comprises one or more speakers and a display screen.

In one embodiment the data which is transmitted is a combination of data and audio or a/v signals, comprising signals which allow the creation of sound from the host device and data which allows the control of the host device. However at any given time it may be the case that only one form of data or signals is transmitted depending on the operation of the source device and/or wireless communication means at that time.

Thus a user can control the host device from the source device and/or wireless communication device and typically the two devices are mechanically engaged so as to effectively form a single device for use. Preferably the user can hold the source device and wireless communication device in combination when operating the same to selectively transmit data to the host device.

In one embodiment the signal transmitted for output is audio and/or video data. Typically auxiliary data is also transmitted to the host device.

In one embodiment, the wireless communication device includes receiving means to allow data transmitted from the host device and/or other devices to be received.

Typically the host device is associated with receiving means for receiving the transmitted data from the wireless communication device. In one embodiment the host device is provided with transmitting means for transmitting auxiliary and/or meta data to the wireless communication device.

In one embodiment data is used to control a display of the source device or wireless communication device. In one embodiment a radio tuner is provided which can send meta data to the wireless communication device to allow the display of meta data on the wireless communication device display, and/or the data can be used to send instructions to the source device to display such data on the display of the source device.

In one embodiment the wireless communication device facilitates two-way control and/or two-way exchange of meta data with the host device.

In one embodiment the receiving means of the host device is formed as part of the host device. In a further embodiment the receiving means of the host device is a separate device for associating with the host device and connected thereto by, for example, a cable connection.

Typically the wireless communication device is provided with connection means to connect to the data source device. Typically the wireless communication device plugs in to the data source device.

In one embodiment the wireless communication device draws power from the data source device.

In a further embodiment the wireless communication device may be provided with its own power source. In this embodiment the wireless communication device can be used to charge the source device.

In one embodiment the wireless communication device includes control means such as control buttons. Typically the control buttons relate to the host device, and may include any, or any combination, of on/off control, volume control, and the like.

In one embodiment the wireless communication device includes a display screen. Typically the wireless communication device includes processing means for processing the auxiliary and/or meta data for display on the display screen, such as station information for a radio tuner. Typically this can use the screen of the source device i.e. an iPod display.

In a further embodiment the wireless communication device includes additional functionality to that of the source device. In one embodiment the additional function is a radio tuner.

In one embodiment the wireless communication device is provided with any or any combination of infra-red and radio frequency transmitters and/or receivers. Typically the audio signals or data is transmitted using radio frequency (RF). Typically the control commands are transmitted using either infra-red or RF frequency. Typically auxiliary and/or meta data is received from the host device via an RF receiver in the wireless communication device.

In a further aspect of the invention there is provided a system for transmitting signals from a hand held source device to a host device, said signals representing audio and or video selected from the source device wherein said system includes a wireless communication device connected to the source device and via which the selected signals are transmitted wirelessly to the host device.

In one embodiment data representing command signals for the host device can also be generated via the source device and/or wireless communication device and transmitted via the wireless communication device to the host device.

In one embodiment the signal for the audio and/or video is transmitted via radio waves and the data for the command signals is transmitted via infra red.

In a further aspect of the invention there is provided a wireless communication device to allow the transmission of data and/or signals from a source device connected thereto to a host device via the wireless communication device wherein said wireless communication device has a first wireless transmission method to allow data or signals from the source device to be transmitted to the host device and a second wireless transmission method to allow data representing command signals generated from the source device and/or wireless communication device to be transmitted to the host device.

In one embodiment the first method is radio frequency and the second method is infra red.

In a yet further aspect of the invention there is provided a method for the control of operation of host device in the form of at least one speaker and/or display screen which are provided to generate audio and/or video respectively, said data and/or signals for said audio and/or video received from a source device remote from the host device and data representing command signals for operation of the host device are selectively generated from the source device and/or a wireless communication device, said method comprising the steps of; selecting on the source device the particular audio and/or video which is to be generated; selectively operating one or more control means on the source device and/or wireless communication device to selectively generate one or more command signals as required; and wherein the source device is connected with the wireless communication device to allow data and/or signals to pass from the source device to the wireless communication device; and transmitting the data and/or signals to the host device via one or more wireless data transmission methods from the wireless communication device.

Specific embodiments of the invention are now described wherein:

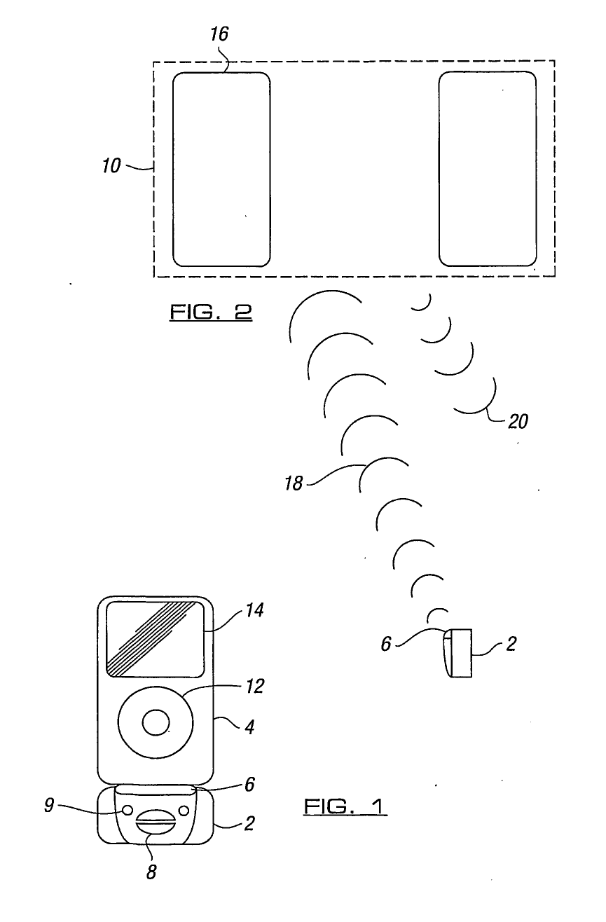

FIG. 1 illustrates a wireless communication device connected to an MP3 player in accordance with one embodiment of the invention

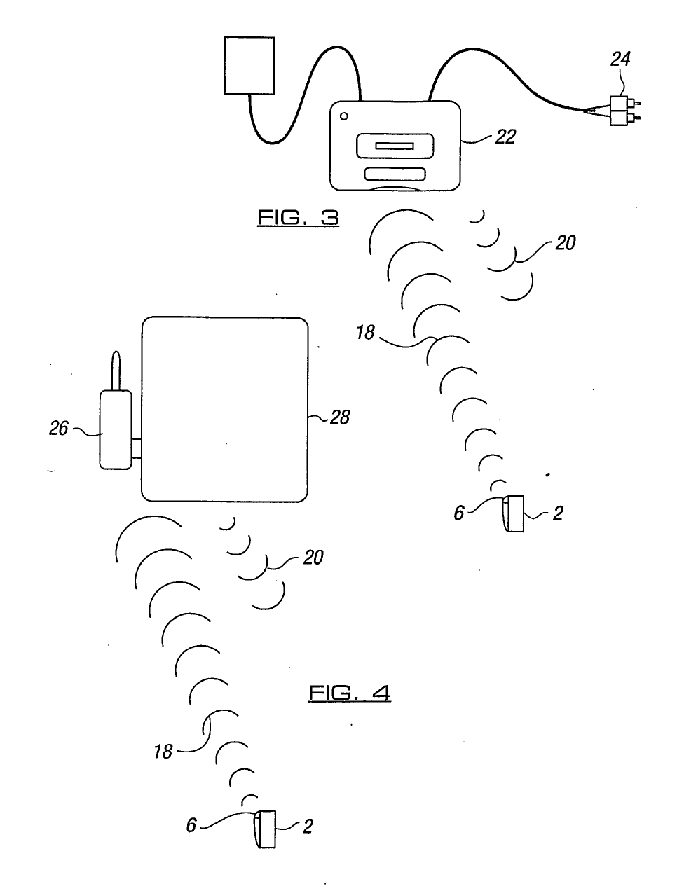

FIG. 2 illustrates use of a wireless communication device in communication with a transceiver formed as part of a host device in the form of a speaker system.

FIG. 3 illustrates use of a wireless communication device in communication with a separate transceiver.

FIG. 4 illustrates use of a wireless communication device in communication with a transceiver adaptor for a radio; and

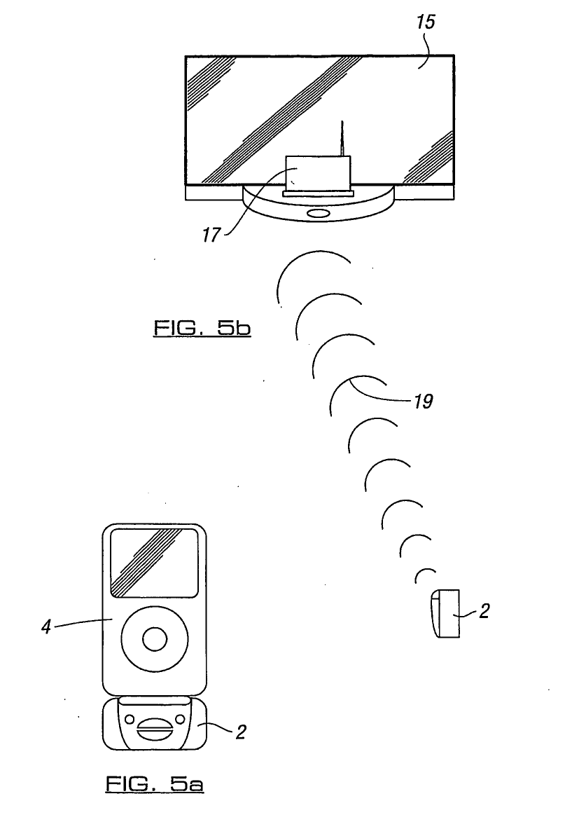

FIGS. 5a and b illustrate use of a wireless communication device in communication with the use of a wireless receiver adaptor to fit in place of a wired source device player dock.

With reference to FIG. 1, there is illustrated a wireless communication device 2 provided, in this embodiment, with transmitting means in the form of an RF wireless transmitter and an infrared transmitter 6, and control buttons 8, 9.

The wireless communication device is connected to a source device such as an MP3 player 4 such as an iPod (RTM), which includes selection means 12 to allow a user to choose a music or video track from those shown on the screen 14 and, when selected, signals representing said selected video and/or audio is transmitted to an host device as will now be described. In one embodiment the RF transmission return path 20 permits signals and/or data from the host device speaker system 10 to be transmitted wirelessly back to the wireless communication device 2 to show data such as volume level of the host device.

Referring to FIG. 2, in which the MP3 player is omitted for clarity, the wireless communication device 2 is in wireless communication with host device in the form of a speaker system 10, which, in this example, includes two amplified speakers 16 and receiving means in the form of a dedicated embedded, IR and RF Receiver or transceiver.

The wireless communication device transmits 18 audio signal from the source device 4 via radio waves to the transceiver such that the audio generated from the transmitted signal is output from the host device speakers 16.

The source device and/or wireless communication device are also used to generate control commands for the host device in this embodiment. In this embodiment the control commands are transmitted via infra-red signals (or RF signals) generated from the wireless communication device and sent to the transceiver/receiver. The control functions which are controlled by the sent data can be, for example, to control operations of the host device such as volume and on/off. In this example these control commands can be generated via the selective operation of the control buttons 8, 9 on the wireless communication device 2.

It should be appreciated that the source device can be docked on the wireless communication device both mechanically to ensure engagement while, for example, the devices are being operated when hand held, in combination, and electrically to allow the transfer of data from the source device to the wireless communication device for onward transmission.

A transceiver in the host device speaker system may also transmit 20 auxiliary and/or meta data to the wireless communication device 2. Such data could include current volume level or other information of the host device such as that relating to the current sound parameters, in the form of a graphic equaliser for example. The wireless communication device may then process such data to illustrate the same on its display screen when the same is provided.

With reference to FIG. 3, there is illustrated a separate transceiver/receiver 22 for receiving data from the wireless communication device 2 in a similar fashion to that described above. The transceiver/receiver 22 is provided with connection means 24 for connecting to a host device such as a stereo, multi-room audio-video system, or other output device to allow control of, and data to be transmitted to, the same. In one embodiment the transmitter/receiver incorporates a circuit to permit volume level control.

With reference to FIG. 4, there is illustrated an adaptor 26 provided with a transceiver for receiving data from the wireless communication device 2 in a similar fashion to that described above. The adaptor 22 (which draws its power from the radio 28) is plugged into a host device in the form of a radio 28 to allow music data to be transferred from an MP3 player connected to the wireless communication device 2, to the radio and output as sound via the radio's speakers. The radio can also be switched on and off or the volume thereof adjusted via the control buttons on the wireless communication device, via the adaptor receiving such control commands from the wireless communication device.

FIGS. 5a and b illustrate a yet further embodiment of the invention. In this case there is provided a source device 4 which is connected to the wireless communication device 2 to once again form a single unit for use. FIG. 5b illustrates the wireless communication device with the source device removed for ease of reference and in this case the device 2 is used to transmit signals wirelessly to a host device in the form of a speaker system 15 which is normally designed to be used with the source device plugged directly into the same. However in accordance with this embodiment of the invention the source device can be used separately and remotely from the host device as in its place in the host device socket there is provided a receiver 17 which allows the reception of the signals 19 from the wireless communication device 2.

This system also allows the control commands for the speaker system 15 to be generated via the source device and/or wireless communication device and so the conventional IR handset which would normally be required to operate the speaker system is no longer required to be used.

With regard to the actual generation of the signals between the wireless communication device and the receiver at the host device then, despite some growth in RF systems, Infra Red (IR) is the most popular method of remote control. Whilst some IR protocol standards exist, most notably Philips RC5 & RC6, most codes are unique to a particular manufacturer. This in practice, means that a particular manufacturer's remote control handset cannot be used to control another manufacturers products. Most of the time, this is an advantage, however when looking to unify control, this poses problems because of the need for a wide range of alternate IR commands for different manufacturer's products. For some applications, the wireless communication device can incorporate fixed commands to work with known receiver devices. However for applications such as that shown in FIGS. 5a and b, there is a requirement to offer a range of different IR command codes. This can be achieved in several different ways.

Firstly a “code library” can be included within the device which is selectable by pressing a special sequence of buttons. This code library may have the capability of being updated from a PC and hence the appropriate codes can be selected with regard to the particular products with which the device is being used.

Secondly, the required IR command codes for a given manufacturer can be stored on a PC and then downloaded onto the wireless communication device, or thirdly the device may incorporate circuitry and software to permit the required codes to be “learnt”.

A further alternative is for the data communication to be fully RF wireless, and for the receiver device to incorporate an IR emitter, so that these commands can be received by the Amplified Speaker system.

Thus in use of the invention a person can plug a wireless communication device into their source device such as a portable mobile phone or MP3 player, and, if required plug in or otherwise connect an adaptor or receiver into the host device via which they want to listen and/or watch the video/audio received from the source device.

Once the system is set up a user can then browse to the track they wish to hear on their portable music player, and the wireless communication device transmits the data to the host device such it is then output and can be listened to by the user.

The user can also switch on or off the host device or adjust the volume thereof remotely via the wireless communication device, and so if sitting down, the user does not have to get up to change the same, and in addition there is no requirement for a separate remote control for such functions.

Furthermore the user may be provided with further information about the host device, such as current volume level or sound parameters, via a display screen on the wireless communication device Thus the user does not have to get up to check the same on the host device.

It will be appreciated by persons skilled in the art that the present invention may also include further additional modifications made to the device which does not affect the overall functioning of the device.

1-20. (canceled)

21. A system for audio and/or video reproduction,
said system including a wireless communication device for association with a source device,
said wireless communication device including transmitting means for transmitting data and/or audio and/or a/v signals from the source device to a host device,
characterized in that the data and/or signals which are transmitted are generated from the source device and/or wireless communication device, and
are used to control at least one feature of operation of the host device and/or allow the generation of audio and/or video therefrom.

22. A system according to claim 21 wherein the data which is transmitted selectively includes control commands for the host device.

23. A system according to claim 21 wherein the host device comprises one or more speakers, or one or more speakers and a display screen.

24. A system according to claim 21 wherein the data which is transmitted include signals which allow the creation of sound from the host device and data which allows the control of at least one operating feature of the host device.

25. A system according to claim 21 wherein the devices are mechanically engaged so as to form a single device for use.

26. A system according to claim 21 wherein the wireless communication device includes receiving means to allow data transmitted from the host device and/or other devices to be received.

27. A system according to claim 21 wherein the host device is provided with transmitting means for transmitting auxiliary and/or meta data to the wireless communication device and/or source device.

28. A system according to claim 27 wherein the data from the host device is used to control a display of the source device or wireless communication device.

29. A system according to claim 27 wherein the host device includes a radio tuner to send meta data to the wireless communication device, display the same on the wireless communication device display, and/or to send meta data to the source device to display such data on the display of the source device.

30. A system according to claim 27 wherein the wireless communication device facilitates two-way control and/or two-way exchange of meta data with the host device.

31. A system according to claim 21 wherein the wireless communication device draws power from the source device.

32. A system for transmitting signals from a hand held source device to a host device,
said signals representing audio and or video selected from the source device wherein said system includes a wireless communication device connected to the source device and via which the selected signals are transmitted wirelessly to the host device and wherein data representing command signals for the host device is generated via the source device and/or wireless communication device and transmitted via the wireless communication device to the host device.

33. A system according to claim 32 wherein the signals for the audio and/or video are transmitted via radio waves and the data for the command signals is transmitted via infra red.

34. A wireless communication device to allow the transmission of data and/or signals from a source device connected thereto to a host device via the wireless communication device wherein said wireless communication device has a first wireless transmission method to allow data or signals from the source device to be transmitted to the host device and a second wireless transmission method to allow data representing command signals generated from the source device and/or wireless communication device to be transmitted to the host device.

35. A method for the control of operation of a host device in the form of at least one speaker and/or display screen which are provided to generate audio and/or video respectively,
said data and/or signals for said audio and/or video received from a source device remote from the host device and data representing command signals for operation of the host device are respectively generated from the source device and/or a wireless communication device, said method comprising the steps of;
selecting on the source device the particular audio and/or video which is to be generated;
selectively operating one or more control means on the source device and/or wireless communication device to selectively generate one or more command signals as required; and
wherein the source device is connected with the wireless communication device to allow data and/or signals to pass from the source device to the wireless communication device; and
transmitting the data and/or signals to the host device via one or more wireless data transmission methods from the wireless communication device.
